(19) United States
(12) Patent Application Publication
(10) Pub. No.: US 2026/0126274 A1
(43) Pub. Date: May 7, 2026

(54) PREPARATION METHOD OF MULTI-BULLET-RESISTANT CERAMIC AND BULLETPROOF INSERT PLATE

(71) Applicant: ZHEJIANG LIGHT-TOUGH COMPOSITE MATERIALS CO., LTD., Huzhou (CN)

(72) Inventors: Hong ZHANG, Huzhou (CN); Wensong LIN, Huzhou (CN); Xiaoping OUYANG, Huzhou (CN)

(73) Assignee: ZHEJIANG LIGHT-TOUGH COMPOSITE MATERIALS CO., LTD., Huzhou (CN)

(21) Appl. No.: 18/951,706

(22) Filed: Nov. 19, 2024

Related U.S. Application Data
(63) Continuation of application No. PCT/CN2022/109161, filed on Jul. 29, 2022.

(30) Foreign Application Priority Data
May 19, 2022 (CN) 2022105540178.2

(51) Int. Cl. F41H 5/04; B32B 5/02; B32B 5/12; B32B 18/00; C04B 35/563; C04B 35/573; C04B 35/626; C04B 35/645; C04B 35/65; C04B 37/00

(52) U.S. Cl. CPC F41H 5/0428; B32B 5/024; B32B 5/12; B32B 18/00; C04B 35/563; C04B 35/573; C04B 35/6261; C04B 35/62695; C04B 35/645; C04B 35/65; C04B 37/008; B32B 2262/0269; B32B 2262/106; B32B 2307/536; B32B 2307/54; B32B 2307/56; B32B 2307/72; B32B 2571/02; C04B 2235/3821; C04B 2235/3826; C04B 2235/6567; C04B 2235/786; C04B 2237/365

(57) ABSTRACT

A preparation method of a multi-bullet-resistant ceramic and a bulletproof insert plate are provided; the ceramic is made by sintering silicon carbide and/or boron carbide and the sintering is one or more of high-temperature sintering, reactive sintering, hot-pressed sintering, or pressureless sintering. The average grain size of the ceramic is 200 to 380 μm, the Vickers hardness is 23.5 GPa to 34 GPa, and the compression strength is 2200 MPa to 3100 MPa. The back bulge generated during bullet penetration can be effectively lowered on the precondition of ensuring the bulletproof insert plate is not penetrated by the bullet, fully satisfying the multi-faceted bulletproof requirements of the new-generation protective insert plate.

### CROSS REFERENCE TO THE RELATED APPLICATIONS

This application is a continuation application of International Application No. PCT/CN2022/109161, filed on Jul. 29, 2022, which is based upon and claims priority to Chinese Patent Application No. 202210554078.2, filed on May 19, 2022, the entire contents of which are incorporated herein by reference.

### TECHNICAL FIELD

The present disclosure relates to a bulletproof insert plate material and a preparation method thereof, and in particular to a preparation method of a multi-bullet-resistant ceramic and a bulletproof insert plate.

### BACKGROUND

The bulletproof ceramic is a core material for a lightweight bulletproof insert plate, which has an effect of bullet breaking and energy consumption on the penetrating bullets. In the modern baffle field environment, the rapid-fire weapons are widely applied, which proposes actual requirements for the multi-bullet-resistance of the protective insert plate.

The patent with the application No. 202010643753.X discloses a bulletproof ceramic unit with closely-arranged structure, with which small ceramic blocks are spliced to increase the multi-bullet-resistant capability of the large armor blocks.

The patent with the application No. 201920946066.8 discloses a bulletproof insert plate structure, in which two layers of small ceramic plates are spliced staggeredly to avoid the bulletproof weakness resulting from ceramic overlapping seams while improving its multi-bullet-resistant capability.

The patent with the application No. 201220010296.1 discloses a bulletproof material plate with composite structure, whose core point is still to form a ceramic layer by splicing the units composed of ceramic plates or ceramic particles.

In the splicing manner of small ceramic blocks, the influence of the ceramic fragments near the bullet points of impact on surrounding ceramic units can be reduced to some extent, such that the other parts of the armor can remain complete to some extent so as to improve its multi-bullet-resistant capability. But the risk brought by the splicing seams is obvious and the wearing comfort brought by the spliced ceramic plates is relatively poor. The latest version of GA141-2010 Policemen Bulletproof Vests of China especially emphasizes that “when selecting the bulletproof vests, the users should take full consideration of the weight and comfort of the bulletproof vests to improve the wearing rate of the bulletproof vests”. At present, most of the users at home and abroad require use of integral ceramic plate as bulletproof panel.

In many research literatures, it is proposed to add a toughening phase in the ceramic, hoping to improve the multi-bullet-resistant capability of the ceramic by improving the toughness of the ceramic. The results of the actual tests demonstrate that under the high-velocity impact load of the bullets, the conventional toughening measures cannot stop the propagation of the cracks on the integral ceramic plate, not helping much in the multi-bullet-resistant capability of the bulletproof insert plate.

### SUMMARY

In order to overcome the shortcomings of the prior arts, the present disclosure provides a preparation method of a multi-bullet-resistant ceramic and a bulletproof insert plate, so as to solve the problems in the prior arts. A bulletproof ceramic composited by silicon carbide or boron carbide or both can, after going through ultrahigh temperature sintering, have coarse grain structure, higher and more uniform hardness and compression strength, and higher impact brittleness. Therefore, a bulletproof insert plate composited by using such ceramic and appropriate backplate has low volume weight and high bulletproofness and thus can be used as insert plate for protecting human bodies to withstand the multi-bullet penetration of small and medium-caliber bullets such as DBP95 type 5.8 mm (stainless steel core) bullets.

In order to achieve the above objects, the present disclosure provides a preparation method of a multi-bullet-resistant ceramic, including: sintering silicon carbide and/or boron carbide. The sintering is one or more of high-temperature sintering, reactive sintering, hot-pressed sintering, or pressureless sintering. In the reactive sintering, the sintering temperature is 1750° C. to 1900° C., the holding time is 4 to 6 hours; in the hot-pressed sintering, the sintering temperature is 2100° C. to 2250° C., the pressure is 30 MPa and the holding time is 2 to 3 hours; in the pressureless sintering, the sintering temperature is 2050° C. to 2150° C. and the holding time is 3 to 5 hours.

Preferably, the silicon carbide and/or boron carbide are obtained by performing ball milling mixing and centrifugation atomization pelletization with a moulding agent or a sintering aid. The time of the ball milling mixing is 12 to 24 h, the inlet temperature of the centrifugation atomization pelletization is 150 to 210° C., and the outlet temperature is 80 to 110° C.; the use amount of the moulding agent or the sintering aid is 2% to 15%.

Preferably, the moulding agent is one or more of phenolic resin, glucose and epoxy resin, and the sintering aid is one or more of carbon (C), metal single element (e.g. Al), metal oxide (e.g. Al₂O₃) and boride (e.g. TiB₂) and the like.

Preferably, the average grain size of the ceramic is 200 to 380 μm, the Vickers hardness is 23.5 GPa to 34 GPa, and the compression strength is 2200 MPa to 3100 MPa.

As another aspect of the present disclosure, the present disclosure provides a multi-bullet-resistant ceramic protective insert plate based on the ceramic. In the insert plate, a crack-arrest layer, a bulletproof ceramic panel and an energy-absorbing backplate are sequentially bonded with a binder from surface to inside; a surface density is less than 25 kg/m² sufficient to withstand four DBP95 type 5.8 mm bullets without full penetration. All back bulges are less than 25 mm.

Preferably, the crack-arrest layer is composed of an aramid woven cloth with a surface density of 0.4 to 0.8 kg/m².

The surface density of the bulletproof ceramic panel is 10.5 to 13.5 kg/m².

The energy-absorbing layer is formed by laminating and hot-curing a unidirectional cloth of polyethylene with ultrahigh molecular weight, with a surface density of 9.2 to 14.0 kg/m².

Preferably, a support layer is disposed between the bulletproof ceramic panel and the energy-absorbing backplate, and the support layer is formed by laminating and hot-curing a carbon fiber unidirectional cloth or an aramid unidirectional cloth, with a surface density of 0 to 1.8 kg/m².

Preferably, the aramid woven cloth is a para-aramid (aroma II) woven cloth or heterocyclic aramid (aroma III) woven cloth, and the aramid unidirectional cloth is a para-aramid (aroma II) unidirectional cloth or heterocyclic aramid (aroma III) unidirectional cloth.

As another aspect of the present disclosure, the present disclosure provides a preparation method of a multi-bullet-resistant ceramic protective insert plate, which includes the following steps:
1) preparing a bulletproof ceramic panel with a multi-bullet-resistant ceramic;
2) pressing and compositing a unidirectional (UD) cloth of polyethylene fiber with ultrahigh molecular weight under the compositing condition of 128° C. and 25 MPa for a compositing time of 25 to 30 minutes, so as to obtain an energy-absorbing backplate;
3) laminating the crack-arrest layer composed of the aramid woven cloth, the bulletproof ceramic panel obtained in step 1) and the energy-absorbing backplate obtained in step 2) sequentially with a binder layer and compositing them under the condition of 128° C. and 1.0 MPa.

Preferably, a support layer is disposed between the bulletproof ceramic panel and the energy-absorbing backplate, and the support layer (4) is prepared with the aramid UD cloth.

Preferably, the support layer is prepared in the following step: pressing and compositing the aramid UD cloth under the condition of 128° C. and 25 MPa for a compositing time of 10 min.

The present disclosure has the following beneficial effects.
1) For the breaking state of the ceramic panel under the high-velocity impact of the small-caliber bullets, the present disclosure employs a bulletproof ceramic with high strength, high hardness and high brittleness such that the ceramic fragments produced by the impact of each bullet on the ceramic significantly consume the kinetic energy of the bullet. Further, the cracks generated near the bullet point of impact on the ceramic panel are widely spaced, which has little influence on the bulletproofness of other bullet points of impact, so as to improve the stable capability of the bulletproof insert plate against multiple bullets.
2) The bulletproof insert plate composited with three or four material layers still has the advantages of light weight and high hardness inherent to the bulletproof ceramic, and the strong supporting effect of the ceramic backplate fully exerts the bullet-breaking efficacy of the ceramic; the crack-arrest layer of the impact surface of the ceramic effectively avoids secondary damage brought about by the splashed ceramic debris.
3) With the use of the energy-absorbing material with high toughness and high specific energy absorption and the support layer backplate, the back bulge generated during bullet penetration can be effectively lowered on the precondition of ensuring the bulletproof insert plate is not penetrated by the bullet, fully satisfying the multi-faceted bulletproof requirements of the new-generation protective insert plate.

### BRIEF DESCRIPTION OF THE DRAWINGS

FIG. 1 is a structural schematic diagram illustrating a bulletproof insert plate according to the present disclosure.

FIG. 2 is a schematic diagram illustrating a position of a bullet point of impact of a bulletproof insert plate.

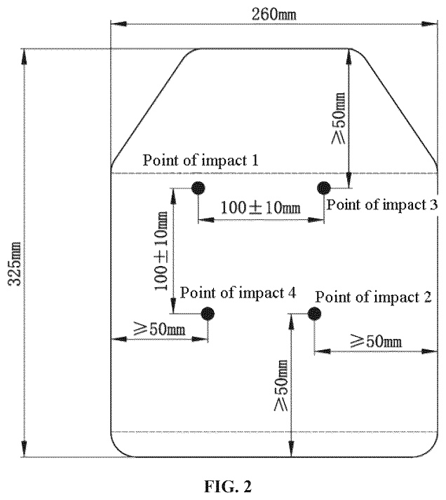

FIGS. 3A-3C are an x-ray perspective image (FIG. 3A) and apparent morphology images (the front surface is shown in FIG. 3B and the back surface is shown in FIG. 3C) of a target plate impacted by four DBP95 type 5.8 mm (steel core) bullets in the example 1.

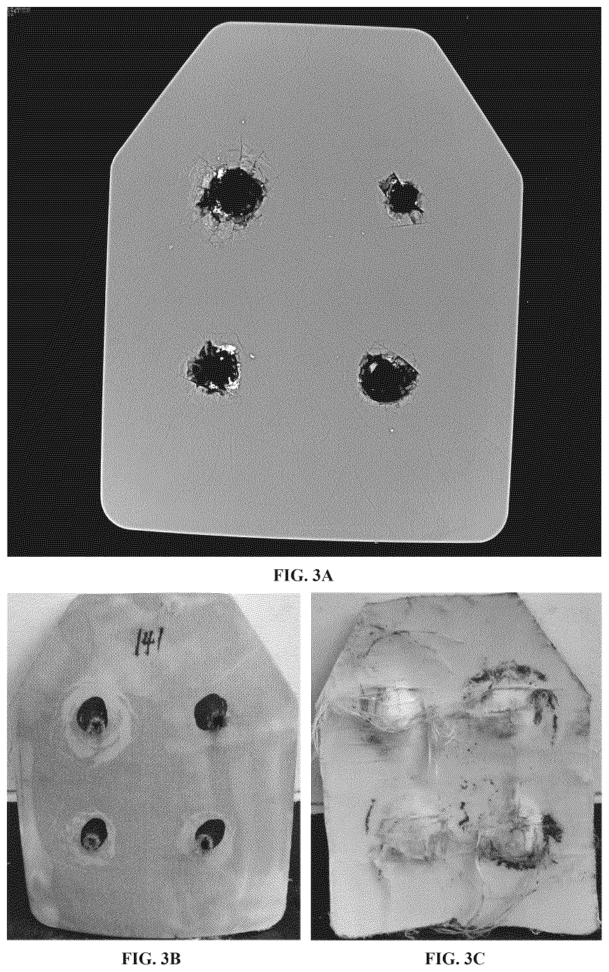

FIGS. 4A-4C are an x-ray perspective image (FIG. 4A) and apparent morphology images (the front surface is shown in FIG. 4B and the back surface is shown in FIG. 4C) of a target plate impacted by four DBP95 type 5.8 mm (steel core) bullets in the example 2.

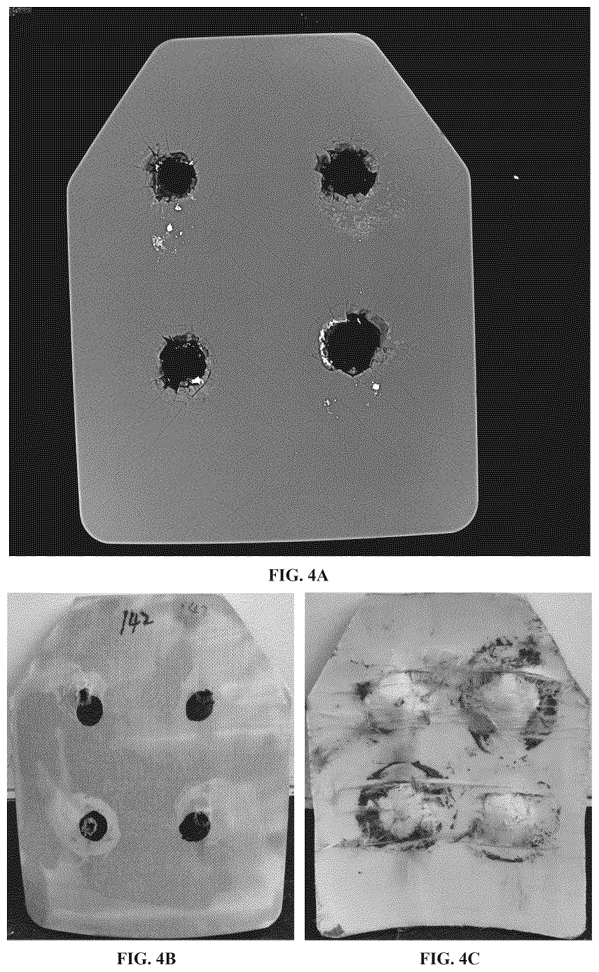

FIGS. 5A-5C are an x-ray perspective image (FIG. 5A) and apparent morphology images (the front surface is shown in FIG. 5B and the back surface is shown in FIG. 5C) of a target plate impacted by four DBP95 type 5.8 mm (steel core) bullets in the example 3.

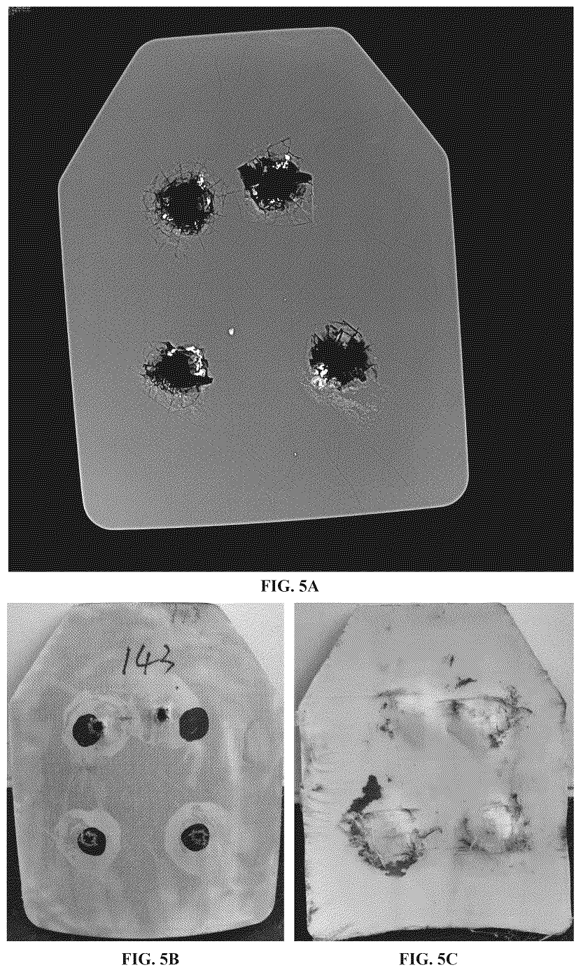

FIGS. 6A-6C are an x-ray perspective image (FIG. 6A) and apparent morphology images (the front surface is shown in FIG. 6B and the back surface is shown in FIG. 6C) of a target plate impacted by four DBP95 type 5.8 mm (steel core) bullets in the example 4.

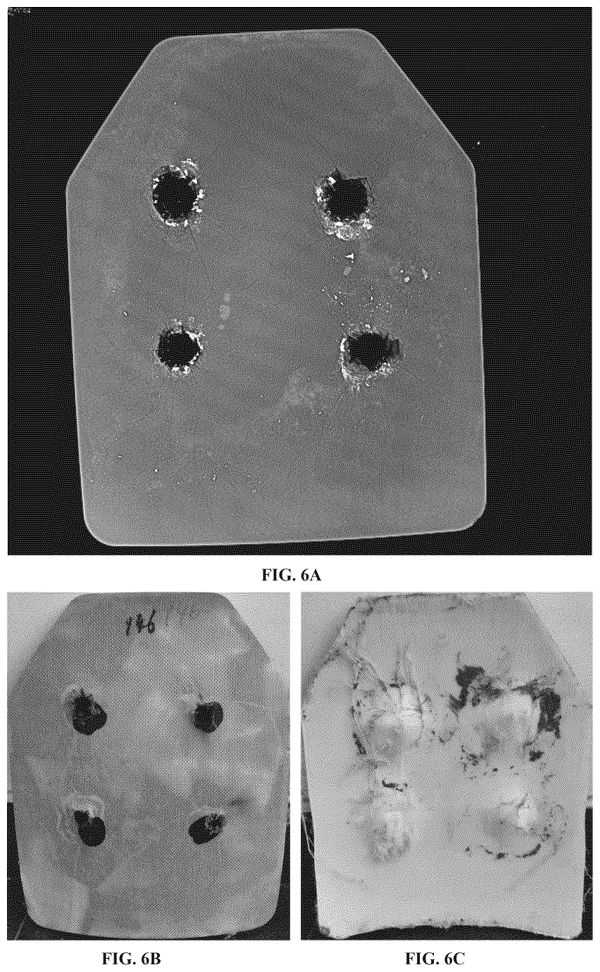

FIGS. 7A-7C are an x-ray perspective image (FIG. 7A) and apparent morphology images (the front surface is shown in FIG. 7B and the back surface is shown in FIG. 7C) of a target plate impacted by four DBP95 type 5.8 mm (steel core) bullets in the example 4.

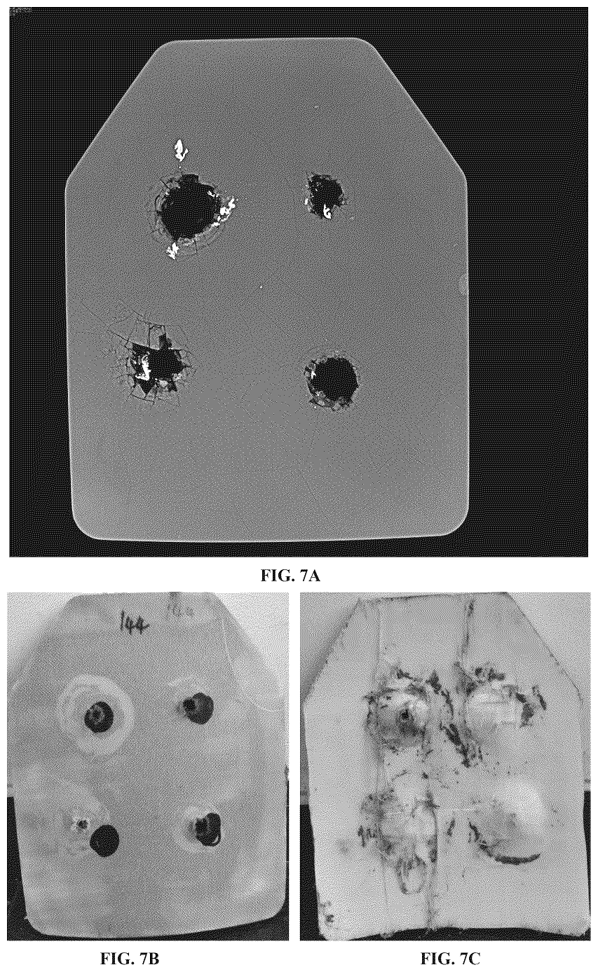

### DETAILED DESCRIPTION OF THE EMBODIMENTS

The technical solutions of the present disclosure will be fully and clearly described below in combination with the examples of the present disclosure. Apparently, the examples described herein are only some examples of the present disclosure rather than all examples. All other examples obtained by those skilled in the arts based on these examples of the present disclosure without carrying out creative work shall fall within the scope of protection of the present disclosure.

### Example 1

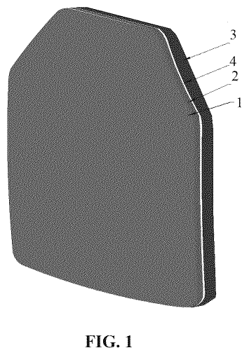

With reference to FIG. 1, the bulletproof insert plate is formed by three layers: a crack-arrest layer, a ceramic panel and an energy-absorbing layer of polyethylene with ultrahigh molecular weight; the ceramic panel is made from silicon carbide and manufactured by a reactive sintering process. The specific preparation method is as follows.
Step 1): ball milling mixing (time: 15 h) and centrifugation atomization pelletization (inlet temperature 195° C. and outlet temperature 90° C.) are performed on silicon carbide powder and phenolic resin. The weight ratio of the phenolic resin is 15%. The mixed powder is pressed to shape and then a silicon cake mainly composed of metal silicon powder is placed on the pressed compact. Under vacuum environment, a dense silicon carbide ceramic is obtained by silicon melt infiltration reaction at the reactive sintering temperature of 1800° C. for a sintering holding time of 5 hours. The main structural performance indexes of the obtained silicon carbide ceramic are: average grain size 210 μm, Vickers hardness (GB/T 16534-2009) 23.8 GPa, compression strength (GBT 4740-1999) 2250 MPa, and average fracture toughness (GB/T23806-2009) 1.75 MPa·m^{1/2}.
Step 2): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 30 min, so as to obtain an energy-absorbing backplate.
Step 3) the crack-arrest layer formed by the aramid woven cloth (surface density 0.4 kg/m²; the aramid woven cloth is a para-aramid (aroma II) woven cloth or heterocyclic aramid (aroma III) woven cloth), the silicon carbide ceramic panel obtained in step 1) (surface density 14.0 kg/m²) and the energy-absorbing backplate (surface density 10.2 kg/m²) of polyethylene fiber with ultrahigh molecular weight obtained in step 2) are sequentially laminated together by EVA binder layer and composited under the condition of 128° C. and 1.0 MPa to obtain a bulletproof insert plate with the size of 260 mm×325 mm and the surface density of 24.8 kg/m². The thickness of each layer, the entire thickness and the specifications of the bulletproof insert plate are indicated in Table 1.

According to the standard of GA141-2010 Policemen Bulletproof Vests, test is performed on the above bulletproof insert plate. One DBP95 type 5.8 mm (steel core) bullet is shot onto proper positions at the upper left part, lower right part, lower left part and upper right part on the insert plate respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, none of the four bullets penetrates the target with the back bulge value being 19.5 to 24.5 mm and averaging at 23.7 mm.

### Example 2

With reference to FIG. 1, the bulletproof insert plate is formed by four layers: a crack-arrest layer, a ceramic panel, an aramid fiber plate, and an energy-absorbing layer of polyethylene with ultrahigh molecular weight; the ceramic panel is made from boron carbide and manufactured by a hot-pressed sintering process. The specific preparation method is as follows.
Step 1): ball milling mixing (time: 12 h) and centrifugation atomization pelletization (inlet temperature 180° C. and outlet temperature 85° C.) are performed on boron carbide powder and phenolic resin. The weight ratio of the phenolic resin is 2%. The mixed powder is pressed to shape and then under vacuum environment, a boron carbide ceramic panel is prepared by the hot-pressed sintering at the hot-pressed sintering temperature of 2200° C. and the pressure of 30 MPa, with a holding time of 2 hours. The main structural performance indexes of the obtained boron carbide ceramic are: average grain size 350 μm, Vickers hardness (GB/T 16534-2009) 33.8 GPa, compression strength (GBT 4740-1999) 3050 MPa, and average fracture toughness (GB/T23806-2009) 1.25 MPa·m^{1/2}.
Step 2): the aramid UD cloth is spread and cut and then placed in order on a mould of a hot press for pressing and compositing under the compositing condition of 128° C. and 25 MPa for the compositing time of 10 min.
Step 3): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 4): the crack-arrest layer formed by the aramid woven cloth (surface density 0.8 kg/m²), the boron carbide ceramic panel obtained in step 1) (surface density 12.2 kg/m²), the aramid support layer obtained in step 2) (surface density 1.8 kg/m²), and the energy-absorbing backplate (surface density 9.8 kg/m²) of polyethylene fiber with ultrahigh molecular weight obtained in step 3) are sequentially laminated together by a binder layer and composited under the condition of 128° C. and 1.0 MPa to obtain a bulletproof insert plate with the size of 260 mm×325 mm and the surface density of 25 kg/m².

According to the standard of GA141-2010 Policemen Bulletproof Vests, test is performed on the above bulletproof insert plate. One DBP95 type 5.8 mm (steel core) bullet is shot onto proper positions at the upper left part, lower right part, lower left part and upper right part on the insert plate respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, none of the four bullets penetrates the target with the back bulge value being 17.2 to 23.5 mm and averaging at 22.1 mm.

### Example 3

With reference to FIG. 1, the bulletproof insert plate is formed by three layers: a crack-arrest layer, a ceramic panel and an energy-absorbing layer of polyethylene with ultrahigh molecular weight; the ceramic panel is made from boron carbide and manufactured by a pressureless sintering process. The specific preparation method is as follows.
Step 1): ball milling mixing (time: 16 h) and centrifugation atomization pelletization (inlet temperature 190° C. and outlet temperature 95° C.) are performed on boron carbide powder and sintering aid. The sintering aid is a mixture of carbon and silicon carbide (1:2), and the weight ratio of the sintering aid is 12%. The mixed powder is pressed to shape and then sintered and held for 3 hours at the temperature of 2050° C. The main structural performance indexes of the obtained boron carbide ceramic are: average grain size 300 μm, Vickers hardness (GB/T 16534-2009) 31.8 GPa, compression strength (GBT 4740-1999) 2950 MPa, and average fracture toughness (GB/T23806-2009) 1.75 MPa·m^{1/2}.
Step 2): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 3): the crack-arrest layer formed by the aramid woven cloth (surface density 0.4 kg/m²), the boron carbide ceramic panel obtained in step 1) (surface density 11.5 kg/m²), and the energy-absorbing backplate (surface density 12.8 kg/m²) of polyethylene fiber with ultrahigh molecular weight obtained in step 2) are sequentially laminated together by a binder layer and composited under the condition of 128° C. and 1.0 MPa to obtain a bulletproof insert plate with the size of 260 mm×325 mm and the surface density of 24.9 kg/m².

According to the standard of GA141-2010 Policemen Bulletproof Vests, test is performed on the above bulletproof insert plate. One DBP95 type 5.8 mm (steel core) bullet is shot onto proper positions at the upper left part, lower right part, lower left part and upper right part on the insert plate respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, none of the four bullets penetrates the target with the back bulge value being 19.2 to 24.6 mm and averaging at 23.2 mm.

### Example 4

With reference to FIG. 1, the bulletproof insert plate is formed by three layers: a crack-arrest layer, a ceramic panel and an energy-absorbing layer of polyethylene with ultrahigh molecular weight; the ceramic panel is a composite ceramic formed by silicon carbide and boron carbide, and manufactured by a reactive sintering process. The specific preparation method is as follows.
Step 1): ball milling mixing (time: 20 h) and centrifugation atomization pelletization (inlet temperature 185° C. and outlet temperature 90° C.) are performed on boron carbide powder, silicon carbide powder and phenolic resin. The weight ratio of boron carbide to silicon carbide to phenolic resin is 75:10:15. The mixed powder is pressed to shape and a silicon cake mainly composed of metal silicon powder is placed on the pressed compact. Under vacuum environment, a dense silicon carbide ceramic is obtained by silicon melt infiltration reaction at the reactive sintering temperature of 1820° C. for a sintering holding time of 5 hours. The main structural performance indexes of the composite ceramic are: average grain size 250 μm, Vickers hardness (GB/T 16534-2009) 26.5 GPa, compression strength (GBT 4740-1999) 2710 MPa, and average fracture toughness (GB/T23806-2009) 1.85 MPa·m^{1/2}.
Step 2): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 3): the crack-arrest layer formed by the aramid woven cloth (surface density 0.4 kg/m²), the composite ceramic panel obtained in step 1) (surface density 14.2 kg/m²), and the energy-absorbing backplate (surface density 10.2 kg/m²) of polyethylene fiber with ultrahigh molecular weight obtained in step 2) are sequentially laminated together by a binder layer and composited under the condition of 128° C. and 1.0 MPa to obtain a bulletproof insert plate with the size of 250 mm×300 mm and the surface density of 25.0 kg/m².

According to the standard of GA141-2010 Policemen Bulletproof Vests, test is performed on the above bulletproof insert plate. One DBP95 type 5.8 mm (steel core) bullet is shot onto proper positions at the upper left part, lower right part, lower left part and upper right part on the insert plate respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, none of the four bullets penetrates the target with the back bulge value being 18.2 to 23.1 mm and averaging at 21.9 mm.

### Control Example 1

The control example 1 is identical to the embodiment 1 in other process parameters than the sintering temperature and time of the silicon carbide ceramic.

With reference to FIG. 1, the bulletproof insert plate is formed by three layers: a crack-arrest layer, a ceramic panel and an energy-absorbing layer of polyethylene with ultrahigh molecular weight; the ceramic panel is made from silicon carbide and manufactured by a reactive sintering process. The specific preparation method is as follows.
Step 1): ball milling mixing (time: 15 h) and centrifugation atomization pelletization (inlet temperature 195° C. and outlet temperature 90° C.) are performed on silicon carbide powder and phenolic resin. The weight ratio of the phenolic resin is 15%. The mixed powder is pressed to shape and then a silicon cake mainly composed of metal silicon powder is placed on the pressed compact. Under vacuum environment, a dense silicon carbide ceramic is obtained by silicon melt infiltration reaction at the reactive sintering temperature of 1630° C. for a sintering holding time of 2 hours. The main structural performance indexes of the obtained silicon carbide ceramic are: average grain size 54 μm, average Vickers hardness (GB/T 16534-2009) 22.0 GPa, average compression strength (GBT 4740-1999) 2110 MPa, and average fracture toughness (GB/T23806-2009) 2.75 MPa·m^{1/2}.
Step 2): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 30 min.
Step 3) the crack-arrest layer formed by the aramid woven cloth (surface density 0.4 kg/m²), the silicon carbide ceramic panel obtained in step 1) (surface density 14.0 kg/m²) and the energy-absorbing backplate (surface density 10.2 kg/m²) of polyethylene fiber with ultrahigh molecular weight obtained in step 2) are sequentially laminated together by binder layer and composited under the condition of 128° C. and 1.0 MPa to obtain a bulletproof insert plate with the size of 260 mm×325 mm and the surface density of 24.8 kg/m².

According to the standard of GA141-2010 Policemen Bulletproof Vests, test is performed on the above bulletproof insert plates (six plates). One DBP95 type 5.8 mm (steel core) bullet is shot onto proper positions at the upper left part, lower right part, lower left part and upper right part on each of the insert plates respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, two of the above six plates each are penetrated by one shot, and the back bulge value of the bullet point of impact not penetrated ranges from 24.2 to 33.1 mm, averaging at 27.9 mm.

### Control Example 2

The control example 2 is identical to the embodiment 2 in other process parameters than the sintering temperature and time of the boron carbide ceramic.

With reference to FIG. 1, the bulletproof insert plate is formed by four layers: a crack-arrest layer, a ceramic panel, an aramid fiber plate, and an energy-absorbing layer of polyethylene with ultrahigh molecular weight; the ceramic panel is made from boron carbide and manufactured by a hot-pressed sintering process. The specific preparation method is as follows.
Step 1): ball milling mixing (time: 12 h) and centrifugation atomization pelletization (inlet temperature 185° C. and outlet temperature 80° C.) are performed on boron carbide powder and moulding agent. The weight ratio of the moulding agent is 2%. The mixed powder is pressed to shape and then under vacuum environment, a boron carbide ceramic panel is prepared by the hot-pressed sintering at the hot-pressed sintering temperature of 1980° C. and the pressure of 30 MPa, with a holding time of 1 hours. The main structural performance indexes of the obtained boron carbide ceramic are: average grain size 50 μm, average Vickers hardness (GB/T 16534-2009) 32.0 GPa, average compression strength (GBT 4740-1999) 3010 MPa, and average fracture toughness (GB/T23806-2009) 3.25 MPa·m^{1/2}.
Step 2): the aramid UD cloth is spread and cut and then placed in order on a mould of a hot press for pressing and compositing under the compositing condition of 128° C. and 25 MPa for the compositing time of 10 min.
Step 3): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 4): the crack-arrest layer formed by the aramid woven cloth (surface density 0.8 kg/m²), the boron carbide ceramic panel obtained in step 1) (surface density 12.2 kg/m²), the aramid support layer obtained in step 2) (surface density 1.8 kg/m²), and the energy-absorbing backplate (surface density 9.8 kg/m²) of polyethylene fiber with ultrahigh molecular weight obtained in step 3) are sequentially laminated together by a binder layer and composited under the condition of 128° C. and 1.0 MPa to obtain a bulletproof insert plate with the size of 260 mm×325 mm and the surface density of 25 kg/m².

According to the standard of GA141-2010 Policemen Bulletproof Vests, test is performed on the above bulletproof insert plates (six plates). One DBP95 type 5.8 mm (steel core) bullet is shot onto proper positions at the upper left part, lower right part, lower left part and upper right part on each of the insert plates respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, one of the above six plates is penetrated by two shots, and one is penetrated by one shot; and the back bulge value of the bullet point of impact not penetrated ranges from 19.2 to 28.5 mm, averaging at 25.5 mm.

### Control Example 3

The control example 3 is identical to the embodiment 3 in other process parameters than the sintering temperature and time of the boron carbide ceramic.

With reference to FIG. 1, the bulletproof insert plate is formed by three layers: a crack-arrest layer, a ceramic panel and an energy-absorbing layer of polyethylene with ultrahigh molecular weight; the ceramic panel is made from boron carbide and manufactured by a pressureless sintering process. The specific preparation method is as follows.
Step 1): ball milling mixing (time: 16 h) and centrifugation atomization pelletization (inlet temperature 190° C. and outlet temperature 95° C.) are performed on boron carbide powder and sintering aid powder. The sintering aid is a mixture of carbon and silicon carbide (1:2), and the weight ratio of the sintering aid is 12%. The mixed powder is pressed to shape and then sintered and held for 2 hours at the temperature of 1980° C. The main structural performance indexes of the obtained boron carbide ceramic are: average grain size 35 μm, average Vickers hardness (GB/T 16534-2009) 29.5 GPa, average compression strength (GBT 4740-1999) 2900 MPa, and average fracture toughness (GB/T23806-2009) 3.05 MPa·m^{1/2}.
Step 2): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 3): the crack-arrest layer formed by the aramid woven cloth (surface density 0.4 kg/m²), the boron carbide ceramic panel obtained in step 1) (surface density 11.5 kg/m²), and the energy-absorbing backplate (surface density 12.8 kg/m²) of polyethylene fiber with ultrahigh molecular weight obtained in step 2) are sequentially laminated together by a binder layer and composited under the condition of 128° C. and 1.0 MPa to obtain a bulletproof insert plate with the size of 260 mm×325 mm and the surface density of 24.9 kg/m².

According to the standard of GA141-2010 Policemen Bulletproof Vests, test is performed on the above bulletproof insert plates (six plates). One DBP95 type 5.8 mm (steel core) bullet is shot onto proper positions at the upper left part, lower right part, lower left part and upper right part on each of the insert plates respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, two of the above six plates each are penetrated by one shot; and the back bulge value of the bullet point of impact not penetrated ranges from 24.2 to 30.1 mm, averaging at 27.0 mm.

### Control Example 4

The control example 4 is identical to the embodiment 4 in other process parameters than the sintering temperature and time of the composite ceramic of silicon carbide/boron carbide.

With reference to FIG. 1, the bulletproof insert plate is formed by three layers: a crack-arrest layer, a ceramic panel and an energy-absorbing layer of polyethylene with ultrahigh molecular weight; the ceramic panel is a composite ceramic formed by silicon carbide and boron carbide, and manufactured by a reactive sintering process. The specific preparation method is as follows.
Step 1): ball milling mixing (time: 20 h) and centrifugation atomization pelletization (inlet temperature 185° C. and outlet temperature 90° C.) are performed on boron carbide powder, silicon carbide powder and phenolic resin. The weight ratio of boron carbide to silicon carbide to phenolic resin is 75:10:15. The mixed powder is pressed to shape and a silicon cake mainly composed of metal silicon powder is placed on the pressed compact. Under vacuum environment, a dense silicon carbide ceramic is obtained by silicon melt infiltration reaction at the reactive sintering temperature of 1580° C. for a sintering holding time of 2 hours. The main structural performance indexes of the composite ceramic are: average grain size 45 μm, average Vickers hardness (GB/T 16534-2009) 25.2 GPa, average compression strength (GBT 4740-1999) 2600 MPa, and average fracture toughness (GB/T23806-2009) 3.25 MPa·m^{1/2}.
Step 2): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 3): the crack-arrest layer formed by the aramid woven cloth (surface density 0.4 kg/m²), the composite ceramic panel obtained in step 1) (surface density 14.2 kg/m²), and the energy-absorbing backplate (surface density 10.2 kg/m²) of polyethylene fiber with ultrahigh molecular weight obtained in step 2) are sequentially laminated together by a binder layer and composited under the condition of 128° C. and 1.0 MPa to obtain a bulletproof insert plate with the size of 250 mm×300 mm and the surface density of 25.0 kg/m².

According to the standard of GA141-2010 Policemen Bulletproof Vests, test is performed on the above bulletproof insert plates (six plates). One DBP95 type 5.8 mm (steel core) bullet is shot onto proper positions at the upper left part, lower right part, lower left part and upper right part on each of the insert plates respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. In the above target test, three of the above six plates each are penetrated by one shot, and the back bulge value of the bullet point of impact not penetrated ranges from 24.2 to 29.1 mm, averaging at 26.9 mm.

### Control Example 5

The control example 5 is similar to the embodiment 2 in basic process line and armor structure. With reference to FIG. 1, the bulletproof insert plate is formed by four layers: a crack-arrest layer, a ceramic panel, an aramid fiber plate, and an energy-absorbing layer of polyethylene with ultrahigh molecular weight; the ceramic panel is made from boron carbide and manufactured by a hot-pressed sintering process. The specific preparation method is as follows.
Step 1): ball milling mixing (time: 12 h) and centrifugation atomization pelletization (inlet temperature 185° C. and outlet temperature 80° C.) are performed on boron carbide powder and phenolic resin. The weight ratio of the phenolic resin is 2%. The mixed powder is pressed to shape and then under vacuum environment, a boron carbide ceramic panel is prepared by the hot-pressed sintering at the hot-pressed sintering temperature of 2050° C. and the pressure of 30 MPa, with a holding time of 2 hours. The main structural performance indexes of the obtained boron carbide ceramic are: average grain size 63 μm, Vickers hardness (GB/T 16534-2009) 29.5 GPa, and compression strength (GBT 4740-1999) 2600 MPa.
Step 2): the aramid UD cloth is spread and cut and then placed in order on a mould of a hot press for pressing and compositing under the compositing condition of 128° C. and 25 MPa for the compositing time of 10 min.
Step 3): the UD cloth of polyethylene fiber with ultrahigh molecular weight (average molecular weight 3 million to 3.1 million) is spread and cut and then placed in order on a mould of a hot press for pressing and compositing under the compositing condition of 128° C. and 25 MPa for the compositing time of 25 min.
Step 4): the crack-arrest layer formed by the aramid woven cloth (surface density 0.8 kg/m²), the boron carbide ceramic panel obtained in step 1) (surface density 12.2 kg/m²), the aramid support layer obtained in step 2) (surface density 1.8 kg/m²), and the energy-absorbing backplate (surface density 9.8 kg/m²) of polyethylene fiber with ultrahigh molecular weight obtained in step 3) are sequentially laminated together by a binder layer and composited under the condition of 128° C. and 1.0 MPa to obtain a bulletproof insert plate with the size of 260 mm×325 mm and the surface density of 25 kg/m².

According to the standard of GA141-2010 Policemen Bulletproof Vests, test is performed on the above bulletproof insert plates. One DBP95 type 5.8 mm (steel core) bullet is shot onto proper positions at the upper left part, lower right part, lower left part and upper right part on each of the insert plates respectively under the test conditions: the distance of the bullet point of impact from the edge of the insert plate is not less than 50 mm; the distance between two bullet points of impact is 100±10 mm; the bullet velocity is 940±10 m/s; angle of incidence is 0°; and the shooting distance is 15 m. Target test is performed on two same target plates obtained in the above process. One of the two target plates is not penetrated by four bullets, with the back bulge value ranging from 24.2 to 32.5 mm and averaging at 28.9 mm; the other target plate is not penetrated by the first, second and fourth bullets but penetrated by the third bullet.

The implementation effect of the all examples and control examples are as indicated in

TABLE 1

| | | | Control | | Control | |
|---|---|---|---|---|---|---|
| Source of ceramic panel | | Example 1 | example 1 | Example 2 | example 2 | Example 3 |
| Manufacturing process of | | Reactive | Reactive | Hot-pressed | Hot-pressed | Pressureless |
| ceramic panel | | sintering | sintering | sintering | sintering | sintering |
| | | Silicon | Silicon | boron | boron | boron |
| | | carbide | carbide | carbide | carbide | carbide |
| ceramic | Vickers | 23.8 | 22.0 | 33.8 | 32.0 | 31.8 |
| performance | hardness/GPa | | | | | |
| | Compression | 2250 | 2110 | 2950 | 3010 | 2950 |
| | strength/MPa | | | | | |
| | fracture | 1.75 | 2.75 | 1.25 | 3.25 | 1.75 |
| | toughness/MPa · m^{-1/2} | | | | | |
| | Grain scale/μm | 210 | 54 | 350 | 50 | 300 |

| | | | | | |
|---|---|---|---|---|---|
| surface density of the crack- | 0.4 | 0.4 | 0.8 | 0.8 | 0.4 |
| arrest layer/kg · m⁻² | | | | | |
| Surface density of the ceramic | 14 | 14 | 12.2 | 12.2 | 11.5 |
| panel/kg · m⁻² | | | | | |
| surface density of the support | / | / | 1.8 | 1.8 | / |
| layer/kg · m⁻² | | | | | |
| surface density of the energy- | 10.2 | 10.2 | 9.8 | 9.8 | 12.8 |
| absorbing layer/kg · m⁻² | | | | | |
| implementation effect (back | All | Some | All | Some | All |
| bulge range/average back | unpenetrated; | penetrated; | unpenetrated; | penetrated; | unpenetrated; |
| bulge)/mm | 19.5-24.5/23.7 | 24.2-33.1/27.9 | 17.2-23.5/22.1 | 19.2-28.5/25.5 | 19.2-24.6/23.2 |

| | | Control | | Control | Control |
|---|---|---|---|---|---|
| Source of ceramic panel | | example 3 | Example 4 | example 4 | example 5 |
| Manufacturing process of | | Pressureless | Reactive | Reactive | Hot-pressed |
| ceramic panel | | sintering | sintering | sintering | sintering |
| | | boron | composite | composite | boron |
| | | carbide | ceramic | ceramic | carbide |
| Ceramic | Vickers hardness/GPa | 29.5 | 26.5 | 25.2 | 29.5 |
| [symbol] | Compression | 2900 | 2710 | 2600 | 2650 |
| | strength/MPa | | | | |
| | fracture | 3.05 | 1.85 | 3.25 | |
| | toughness/MPa · m^{-1/2} | | | | |
| | Grain scale/μm | 35 | 250 | 45 | 63 |

| | | | | |
|---|---|---|---|---|
| surface density of the crack- | 0.4 | 0.4 | 0.4 | 0.8 |
| arrest layer/kg · m⁻² | | | | |
| Surface density of the | 11.5 | 14.2 | 14.2 | 12.2 |
| ceramic panel/kg · m⁻² | | | | |
| surface density of the support | / | / | / | 1.8 |
| layer/kg · m⁻² | | | | |
| surface density of the energy- | 12.8 | 10.2 | 10.2 | 9.8 |
| absorbing layer/kg · m⁻² | | | | |
| implementation effect (back | Some | All | Some | Penetrated; |
| bulge range/average back | penetrated; | unpenetrated; | penetrated; | 24.2-32.5 |
| bulge)/mm | 24.2-30.1/27.0 | 18.2-23.1/21.9 | 19.5-24.5/23.7 | |

[symbol]

indicates data missing or illegible when filed

The present disclosure provides a multi-bullet-resistant ceramic and in particular a preparation method of a bulletproof ceramic made from silicon carbide or boron carbide or both of them. The ceramic undergoes ultrahigh temperature sintering and then has coarse grain structure, higher and more uniform hardness and compression strength, and higher impact brittleness. Therefore, it is a ceramic having specific metallographic structure and mechanical performance. The main mechanism for the composite armor to withstand the penetration of bullets is as follows: the bulletproof ceramic panel exerts its bullet-breaking efficacy based on its characteristics of high hardness and high strength to break the penetrating bullets; in the continued penetration of the bullets, sharp abrasion with the debris produced by the ceramic break further consumes the mass and kinetic energy of the bullets; the bullets penetrating the ceramic panel enable the fiber material of the backplate to generate shear and elongation, so as to consume remaining kinetic energy of the bullets and lodge the bullets into the backplate, thus preventing the bullets from penetrating the armor. The support material in the bulletproof backplate of the present disclosure has relatively high rigidity capable of preventing the ceramic panel from generating excessively bending during the penetration process of the bullets so as to fully exert the bullet-breaking efficacy of the ceramic panel. Furthermore, the increased grain size of the ceramic microstructure can improve the hardness and compression strength of the ceramic and the proper brittleness performance also can enable the ceramic around the bullet point of impact to be fully broken, so as to increase the consumption of the kinetic energy and mass of the bullets and make larger the included angle (spacing) between multiple cracks generated. In this way, the subsequent bullet point of impact is more possibly located at a complete ceramic position, improving its capability against penetration. The bulletproof insert plate composited by such ceramics and the proper backplate has the advantages of low volume weight and high bulletproofness and thus can be used as insert plate for protecting human body to withstand the multi-bullet penetration of medium and small-caliber bullets, for example, DBP95 type 5.8 mm (steel core) bullets.

Furthermore, for small-caliber bullets, the direct breaking scope (broken cone area) generated on the ceramic panel is relatively small. But the cracks generated by a previous bullet on the ceramic panel may directly affect the bulletproof efficacy of the subsequent bullet point of impact. In an ideal state, the cracks are limited within a limited scope. But, for those brittle materials such as ceramics, it is impossible to achieve the ideal state. This is also a major reason why the actual test on many solutions for toughening the ceramics is poor.

The above descriptions are about preferred embodiments of the present disclosure. It should be pointed out that those improvements and modifications made by those skilled in the arts without departing from the principle of the present disclosure shall fall within the scope of protection of the present disclosure.

What is claimed is:

1. A preparation method of a multi-bullet-resistant ceramic, comprising sintering silicon carbide and/or boron carbide, wherein sintering is one or more of high-temperature sintering, reactive sintering, hot-pressed sintering, or pressureless sintering; in the reactive sintering, a sintering temperature is 1750° C. to 1900° C., a holding time is 4 to 6 hours; in the hot-pressed sintering, a sintering temperature is 2100° C. to 2250° C., a pressure is 30 Mpa, and a holding time is 2 to 3 hours; in the pressureless sintering, a sintering temperature is 2050° C. to 2150° C., and a holding time is 3 to 5 hours.

2. The preparation method of the multi-bullet-resistant ceramic of claim 1, wherein the silicon carbide and/or the boron carbide are obtained by performing ball milling mixing and centrifugation atomization pelletization with a moulding agent or a sintering aid; a time of the ball milling mixing is 12 to 24 h, an inlet temperature of the centrifugation atomization pelletization is 150 to 210° C., and an outlet temperature is 80 to 110° C.; a use amount of the moulding agent or the sintering aid is 2% to 15%.

3. A ceramic made by the preparation method of the multi-bullet-resistant ceramic of claim 1, wherein an average grain size of the ceramic is 200 to 380 μm, Vickers hardness is 23.5 GPa to 34 GPa, and a compression strength is 2200 MPa to 3100 MPa.

4. A multi-bullet-resistant ceramic protective insert plate based on the ceramic of claim 3, wherein a crack-arrest layer, a bulletproof ceramic panel, and an energy-absorbing backplate are sequentially bonded with a binder from surface to inside; a surface density is less than 25 kg/m² sufficient to withstand four DBP95 type 5.8 mm bullets without a full penetration, and all back bulges are less than 25 mm.

5. The multi-bullet-resistant ceramic protective insert plate of claim 4, wherein the crack-arrest layer is composed of an aramid woven cloth with a surface density of 0.4 to 0.8 kg/m²; a surface density of the bulletproof ceramic panel is 10.5 to 13.5 kg/m²; an energy-absorbing layer is formed by laminating and hot-curing a unidirectional (UD) cloth of polyethylene with an ultrahigh molecular weight, with a surface density of 9.2 to 14.0 kg/m².

6. The multi-bullet-resistant ceramic protective insert plate of claim 5, wherein a support layer is disposed between the bulletproof ceramic panel and the energy-absorbing backplate, and the support layer is formed by laminating and hot-curing a carbon fiber unidirectional cloth or an aramid unidirectional cloth, with a surface density less than 1.8 kg/m².

7. The multi-bullet-resistant ceramic protective insert plate of claim 6, wherein the aramid woven cloth is a para-aramid (aroma II) woven cloth or a heterocyclic aramid (aroma III) woven cloth, and the aramid unidirectional cloth is a para-aramid (aroma II) unidirectional cloth or a heterocyclic aramid (aroma III) unidirectional cloth.

8. A preparation method of the multi-bullet-resistant ceramic protective insert plate of claim 4, comprising the following steps:
1) preparing the bulletproof ceramic panel with the multi-bullet-resistant ceramic;
2) pressing and compositing a unidirectional cloth of a polyethylene fiber with an ultrahigh molecular weight under a compositing condition of 128° C. and 25 MPa for a compositing time of 25 to 30 minutes, to obtain the energy-absorbing backplate;
3) laminating the crack-arrest layer composed of an aramid woven cloth, the bulletproof ceramic panel obtained in the step 1), and the energy-absorbing backplate obtained in the step 2) sequentially with a binder layer and compositing under a condition of 128° C. and 1.0 MPa.

9. The preparation method of the multi-bullet-resistant ceramic protective insert plate of claim 8, wherein a support layer is disposed between the bulletproof ceramic panel and the energy-absorbing backplate, and the support layer is prepared with an aramid UD cloth.

10. The preparation method of the multi-bullet-resistant ceramic protective insert plate of claim 9, wherein the support layer is prepared in the following step: pressing and compositing the aramid UD cloth under a condition of 128° C. and 25 MPa for a compositing time of 10 min.

11. The ceramic of claim 3, wherein in preparation method of the multi-bullet-resistant ceramic, the silicon carbide and/or the boron carbide are obtained by performing ball milling mixing and centrifugation atomization pelletization with a moulding agent or a sintering aid; a time of the ball milling mixing is 12 to 24 h, an inlet temperature of the centrifugation atomization pelletization is 150 to 210° C., and an outlet temperature is 80 to 110° C.; a use amount of the moulding agent or the sintering aid is 2% to 15%.

12. The multi-bullet-resistant ceramic protective insert plate of claim 4, wherein a support layer is disposed between the bulletproof ceramic panel and the energy-absorbing backplate, and the support layer is formed by laminating and hot-curing a carbon fiber unidirectional cloth or an aramid UD cloth, with a surface density less than 1.8 kg/m².

13. The preparation method of the multi-bullet-resistant ceramic protective insert plate of claim 8, wherein in the multi-bullet-resistant ceramic protective insert plate, the crack-arrest layer is composed of the aramid woven cloth with a surface density of 0.4 to 0.8 kg/m²; a surface density of the bulletproof ceramic panel is 10.5 to 13.5 kg/m²; an energy-absorbing layer is formed by laminating and hot-curing a unidirectional cloth of polyethylene with an ultrahigh molecular weight, with a surface density of 9.2 to 14.0 kg/m².

14. The preparation method of the multi-bullet-resistant ceramic protective insert plate of claim 13, wherein in the multi-bullet-resistant ceramic protective insert plate, a support layer is disposed between the bulletproof ceramic panel and the energy-absorbing backplate, and the support layer is formed by laminating and hot-curing a carbon fiber unidirectional cloth or an aramid unidirectional cloth, with a surface density less than 1.8 kg/m².

15. The preparation method of the multi-bullet-resistant ceramic protective insert plate of claim 14, wherein in the multi-bullet-resistant ceramic protective insert plate, the aramid woven cloth is a para-aramid (aroma II) woven cloth or a heterocyclic aramid (aroma III) woven cloth, and the aramid unidirectional cloth is a para-aramid (aroma II) unidirectional cloth or a heterocyclic aramid (aroma III) unidirectional cloth.

16. A multi-bullet-resistant ceramic protective insert plate based on the ceramic of claim 11, wherein a crack-arrest layer, a bulletproof ceramic panel, and an energy-absorbing backplate are sequentially bonded with a binder from surface to inside; a surface density is less than 25 kg/m² sufficient to withstand four DBP95 type 5.8 mm bullets without a full penetration, and all back bulges are less than 25 mm.

17. The multi-bullet-resistant ceramic protective insert plate of claim 16, wherein the crack-arrest layer is composed of an aramid woven cloth with a surface density of 0.4 to 0.8 kg/m²; a surface density of the bulletproof ceramic panel is 10.5 to 13.5 kg/m²; an energy-absorbing layer is formed by laminating and hot-curing a unidirectional cloth of polyethylene with an ultrahigh molecular weight, with a surface density of 9.2 to 14.0 kg/m².

18. The multi-bullet-resistant ceramic protective insert plate of claim 16, wherein a support layer is disposed between the bulletproof ceramic panel and the energy-absorbing backplate, and the support layer is formed by laminating and hot-curing a carbon fiber unidirectional cloth or an aramid unidirectional cloth, with a surface density less than 1.8 kg/m².

19. The multi-bullet-resistant ceramic protective insert plate of claim 17, wherein a support layer is disposed between the bulletproof ceramic panel and the energy-absorbing backplate, and the support layer is formed by laminating and hot-curing a carbon fiber unidirectional cloth or an aramid unidirectional cloth, with a surface density less than 1.8 kg/m².

20. The multi-bullet-resistant ceramic protective insert plate of claim 19, wherein the aramid woven cloth is a para-aramid (aroma II) woven cloth or a heterocyclic aramid (aroma III) woven cloth, and the aramid unidirectional cloth is a para-aramid (aroma II) unidirectional cloth or a heterocyclic aramid (aroma III) unidirectional cloth.
